(19) United States
(12) Patent Application Publication
(10) Pub. No.: US 2021/0323132 A1
(43) Pub. Date: Oct. 21, 2021

(54) NAIL GUN EXTENSION

(71) Applicant: Brad Bateman, St. George, UT (US)

(72) Inventor: Brad Bateman, St. George, UT (US)

(21) Appl. No.: 17/045,465

(22) PCT Filed: Apr. 3, 2019
(86) PCT No.: PCT/US2019/025651

§ 371 Date: Mar. 5, 2021

Related U.S. Application Data
(60) Provisional application No. 62/651,966, filed on Apr. 3, 2018.

(51) Int. Cl. B25C 7/00

(52) U.S. Cl. CPC B25C 7/00; B25C 1/04

(57) ABSTRACT

An extension for a nail gun includes a holder sized and configured to receive the nail gun. The extension includes an actuator, which is coupled to the holder. The extension includes a handle, which includes a trigger. The trigger of the handle is operably coupled to the actuator such that in response to actuation of the trigger of the handle, the actuator is configured to actuate a trigger of the nail gun. The extension includes an elongated connector disposed between the holder and the handle.

### BACKGROUND

A nail gun is used to secure nails within frames, walls, and numerous other locations. Frequently, nail guns need to be used to insert nails at elevated heights, which can be difficult or frustrating to reach while using a ladder. A user may spend excessive energy and time repeatedly shifting a location of the ladder and climbing up and down the ladder, which may lead to an increase risk of falling and injury.

### BRIEF SUMMARY OF THE INVENTION

The present disclosure relates generally to an extension for a nail gun, as well as related devices, systems, and methods. In some embodiments, the extension supports the nail gun in an elevated position, which may enable a user to apply nails to a surface without having to use a ladder. In some embodiments, the user may use the extension in combination with a ladder.

In some embodiments, the extension includes a holder sized and configured to receive the nail gun. In some embodiments, the holder includes a mounting bracket and/or a securement strap. In some embodiments, the holder further includes one or more quick-release straps that may be adjusted to accommodate a variety of nail guns. In some embodiments, the extension includes an actuator. In some embodiments, the actuator includes a hook, band, or another suitable structure capable of actuating the trigger of the nail gun.

In some embodiments, the extension includes a handle, which includes a trigger. In some embodiments, the trigger of the handle is operably coupled to the actuator such that in response to actuation of the trigger of the handle, the actuator is configured to actuate a trigger of the nail gun.

In some embodiments, the extension includes an elongated connector, which is disposed between the holder and the handle. In some embodiments, the holder is disposed at a first end of the elongated connector, and the handle is disposed at a second end of the elongated connector. In some embodiments, the trigger of the handle is operably connected to the actuator via a cable extending through the elongated connector. In some embodiments, the trigger of the handle is operably connected to the actuator via a wireless connection. In some embodiments, the trigger may be optionally connected to a variety of locations, as may be desired by a user.

In some embodiments, the elongated connector includes one or more adjustable elbow joints. In some embodiments, the elongated connector includes a first adjustable elbow joint disposed towards the holder and/or a second adjustable elbow joint disposed towards the handle. In some embodiments, the extension further includes one more additional handles to provide additional gripping surfaces or structures to aid a user in holding and controlling the extension during use. In some embodiments, the extension includes another handle disposed between the second adjustable elbow joint and the first elbow joint and/or another handle disposed between the handle and the second adjustable elbow joint. In some embodiments, a position of one or more of the handles is adjustable along a length of the extension.

In some embodiments, the elongated connector includes one or more structures adapted to maintain a desired position of an air hose or power cord or a nail gun coupled to the extension. In some embodiments, the one or more structures comprises a rod or rod-like structure. In some embodiments, the one or more structures comprises one or more loops which is positioned and configured to hold an air hose or electrical cord of a nail gun in a preferred position.

In some embodiments, the extension includes a rotating wheel, which is coupled to the holder. In some embodiments, the rotating wheel includes one or more flat edges disposed along a circumference of the rotating wheel. In some embodiments, the wheel is configured to roll along a surface such that the nail gun fires at regular intervals. In some embodiments, the rotating wheel includes one or more adjustable edges, which may each be movable between an extended and a retracted position.

In some embodiments, the extension includes a wheel unit, which includes the rotating wheel and a support extending between the rotating wheel and the holder. In some embodiments, the support includes a slot. In some embodiments, a position of the rotating wheel is adjustable within the slot. In some embodiments, an angle of the rotating wheel with respect to the holder is adjustable. In some embodiments, the rotating wheel is removably coupled near or proximate the holder. For example, one or more bolts or rivets securing the support near or proximate the holder is removed.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE SEVERAL VIEWS OF THE DRAWINGS

Example embodiments will be described and explained with additional specificity and detail through the use of the accompanying drawings in which:

FIG. 1 is an upper perspective view of an example extension coupled with an example nail gun, according to some embodiments;

FIG. 2A is an upper perspective view of an example holder and example actuator, according to some embodiments;

FIG. 2B is a rear perspective view of the holder of FIG. 2A, illustrating an example handle of the nail gun disposed within the holder, according to some embodiments;

FIG. 2C is a perspective of an extension of the present invention, according to some embodiments;

FIG. 2D is a detailed perspective view of the holder of FIG. 2C, illustrating an example holder, according to some embodiments;

FIG. 2E is a detailed side view of the holder of FIG. 2C, illustrating an example holder and a nail gun disposed and secured within an opening of the holder, according to some embodiments;

FIG. 2F is a detailed perspective view of a handle adjustably and pivotally coupled to a channel provided in an elongated connector of an extension, according to some embodiments;

FIG. 3A is an upper perspective view of an example adjustable elbow joint, according to some embodiments;

FIG. 3B is an upper perspective view of another example adjustable elbow joint, according to some embodiments;

FIG. 3C is a side view of another adjustable elbow joint disposed between an elongated connector and a lower extension member, shown in various possible angles of adjustment, according to some embodiments;

FIG. 4A is an upper perspective view of an example wheel unit, according to some embodiments;

FIG. 4B is an upper perspective view of the wheel unit coupled to the extension of FIG. 1, illustrating an example rotating wheel rotated to allow firing of the nail gun, according to some embodiments;

FIG. 4C is an upper perspective view of the wheel unit coupled to the extension of FIG. 1, illustrating the rotating wheel rotated to prevent firing of the nail gun, according to some embodiments;

FIG. 4D is an upper perspective view of the wheel unit coupled to the extension of FIG. 1, illustrating the wheel unit disposed at an angle with respect to the extension and rotated to allow firing of the nail gun, according to some embodiments;

FIG. 4E is an upper perspective view of the wheel unit coupled to the extension of FIG. 1, illustrating the wheel unit disposed at an angle with respect to the holder and rotated to prevent firing of the nail gun, according to some embodiments;

FIG. 5A is an upper perspective view of an example rotating wheel, illustrating example adjustable edges in a curved configuration, according to some embodiments; and

FIG. 5B is an upper perspective view of the rotating wheel of FIG. 5A, illustrating the adjustable edges in retracted position, according to some embodiments.

### DESCRIPTION OF EMBODIMENTS

Referring now to FIG. 1, an extension device 14 of the present invention is shown in use with a pneumatic nail gun 10, as is common in the art. In some embodiments, nail gun 10 includes a trigger 12. In some embodiments, the trigger 12 includes a finger trigger configured to be operated by a finger of a user when the nail gun 10 is removed from an extension 14. In some embodiments, the nail gun 10 may also include a safety tip 16, which is disposed on a nose of the nail gun 10. In some embodiments, extension 14 is compatible with any suitable type of nail gun. For example, in some embodiments extension 14 is compatible with at least one nail gun 10 selected from the group consisting of a pneumatic nailer, an electric nailer, a battery-powered nailer, a fuel-driver nailer, a coil-style nailer, a strip-style nailer, a framing nailer, a roofing nailer, a flooring nailer, a palm nailer, a finishing nailer, a stapler, a tacker, and a brad nailer.

In some embodiments, the nail gun 10 may fire or discharge a nail when the trigger 12 and safety tip 16 are actuated in any order. In some embodiments, the nail gun 10 may only fire the nail in response to the trigger 12 and the safety tip 16 being actuated in a particular order. In some embodiments, first, the safety tip 16 must be pushed into a surface, and then the trigger 12 must be actuated to fire the nail, commonly known as “single-actuation” firing. In some embodiments, first, the trigger 12 must be actuated, and then the safety tip 16 must be pushed into the surface to fire each nail, commonly known as “single-sequential” firing. In some embodiments, if the trigger 12 remains squeezed by the user, a nail is driven each time the safety tip 16 is compressed or pushed in, commonly known as “bump” firing. In some embodiments, the trigger 12 and the safety tip 16 must be actuated each time a nail is fired, commonly known as “full-sequential” firing.

In some embodiments, extension 14 includes a holder 18 sized and configured to receive and support a nail gun 10. In some embodiments, holder 18 includes or corresponds to an upper portion or end of the extension 14. Holder 18 may comprise any shape, size or configuration compatible for use with a desired nail gun. In some embodiments, holder 18 comprises a universal shape or configuration that is compatible with a wide variety of nail guns. In some embodiments, holder 18 is a modular part that may be removed and interchanged with one or more nail gun-specific holders 18, such that a user would select and modify extension 14 with a specific holder 18 design for use with the user's specific brand, model, shape, and/or size of nail gun. In some embodiments, extension 14 further comprises one or more adapters (not shown) for use with holder 18, wherein the one or more adapters have at least one shape, surface or structural feature that improves contact or otherwise optimizes contact between holder 18 and a nail gun.

In some embodiments, the extension 14 includes an actuator 20, which is coupled near or proximate the holder 18 or another portion of the extension 14. In some embodiments, the actuator 20 extends from the holder 18. In some embodiments, the actuator 20 extends through an opening in the extension 14 or the holder 18. In some embodiments, the actuator 20 is routed along an external surface of extension 14 and/or holder 18. In some embodiments, the actuator 20 includes a hook, band, or another suitable structure capable of actuating the trigger 12 of the nail gun 10. In some embodiments, the actuator 20 is secured about the trigger 12 of the nail gun 10. In some embodiments, a position of actuator 20 is maintained in proximity to trigger 12 such that actuator 20 is capable of contacting, pulling and/or otherwise actuating trigger 12 during use of extension 14.

In some embodiments, the extension 14 includes a trigger 24. Trigger 24 may include any size, shape, or configuration compatible for use with the present invention. Trigger 24 may further be positioned at various locations on extension 14. In some embodiments, trigger 24 is permanently positioned at a single location on extension 14. In some embodiments, trigger 24 is capable of being positioned at two or more locations on extension 14. In some embodiments, extension 14 comprises two or more triggers 24. In some embodiments, extension 14 comprises at least two triggers 24, wherein each trigger is synchronistically connected to actuator 20. In some embodiments, extension 14 comprises at least two triggers 24, wherein each trigger is asynchronistically connected to actuator 20. In some embodiments, a user may select one of two or more trigger 24 for connection to actuator 20.

In some embodiments, the extension 14 includes a terminal grip or handle 22 positioned at a lower portion or end of the extension 14 that is opposite the holder 18. In some embodiments, terminal handle 22 further comprises a trigger 24. In some embodiments, the trigger 24 is operably coupled to the actuator 20 such that in response to actuation of the trigger 24, the actuator 20 pulls, pushes, contacts or otherwise actuates the trigger 12 of the nail gun 10. In some embodiments, the trigger 24 includes at least one or a thumb trigger or a finger trigger that is operated as the user grips the handle 22. In some embodiments, the trigger 24 is actuated by the movement of one or more fingers of a user. In some embodiments, the trigger 24 is actuated by the movement of the user's thumb. In some embodiments, the trigger 24 is actuated by squeezing, depressing, pushing, pulling or sliding the trigger 24.

In some embodiments, the extension 14 includes an elongated connector 26, which is disposed between the holder 18 and the handle 22. In some embodiments, the holder 18 may extend in a forward direction from the elongated connector 26 or towards the safety tip 16 of the nail gun 10. In some embodiments, the holder 18 is disposed at a first or upper end of the elongated connector 26 and the handle 22 is disposed at a second or lower end of the elongated connector 26. In some embodiments, the handle 22 is disposed on a lower portion of the elongated connector 26. In some embodiments, the actuator 20 is disposed on an upper portion of the elongated connector 26.

In some embodiments, the trigger 24 is operably connected to the actuator 20 via a wire or cable 28, which may extend through the elongated connector 26. In some embodiments, cable 28 is routed over an external surface of at least one of holder 18, elongated connector 26, and handle 22. In some embodiments, the cable 28 may physically pull on the actuator 20 in response to depressing or squeezing the trigger 24. In some embodiments, in response to the physical pulling of the cable 28, the actuator 20 may depress or squeeze the trigger 12 of the nail gun 10.

In some embodiments, the trigger 24 is operably connected to the actuator 20 via a wireless connection. In some embodiments, a sensor is configured to detect actuation of the trigger 24 and send a signal to actuate a motor operable coupled to actuator 20. In some embodiments, the motor is configured to actuate the actuator 20, which squeezes, depresses or otherwise actuates the trigger 12 of the nail gun 10.

In some embodiments, the elongated connector 26 includes one or more adjustable elbow joints 30. In some embodiments, the elongated connector 26 includes a first adjustable elbow 30a joint disposed towards the holder 18 and/or a second adjustable elbow joint 30b disposed towards the terminal handle 22. In some embodiments, the elongated connector 26 includes one or more other grips or handles 32.

In some embodiments, the extension 14 includes a handle 32a disposed between the second adjustable elbow joint 30b and the first elbow joint 30a. In some embodiments, the handle 32a includes a loop or D-handle. In some embodiments, the loop or D-handle portion of handle 32a is removable coupled to a base. In some embodiments, a variety of differently shaped and/or configured handles may be attached to the base of handle 32a. In some embodiments, handle 32a and/or a base of handle 32a may be selectively moved and secured to a variety of positions along elongated connector 26.

In some embodiments, the elongated connector 26 includes a handle 32b, which is disposed between the terminal handle 22 and the second adjustable elbow joint 30b. In some embodiments, a shape of the handle 22 and/or the other handles 32 may vary. For example, the handle 22 and/or the other handles 32 include a loop, an extension, a rod, a D-handle, or another suitable shape or feature. In some embodiments, the terminal handle 22 and/or the other handles 32 is constructed of a rigid or semi-rigid material. In some embodiments, at least one of handles 22 and 32 is constructed of a flexible and/or semi-flexible material (such as a tether or strap). In some embodiments, a location, position, rotation and/or angle of the terminal handle 22 and/or the other handles 32 is adjustable.

In some embodiments, the elongated connector 26 includes a rod, pole, beam or similarly compatible structure. In some embodiments, elongated connector 26 includes one or more channels for compatibly receiving one or more elements of the invention. For example, in some embodiments elongated connector 26 comprises a channel for selectively and/or adjustable receiving handle 32. In some embodiments, the elongated connector 26 includes one or more retainers or loops 34, which is configured to hold an air hose (or electrical cable) 36 of the nail gun 10. In some embodiments, the extension is constructed using metal, plastic, composite fiber, and/or other suitable materials. In some embodiments, the extension 14 may measure approximately 60 inches in total length. However, it is understood that the extension 14 includes various sizes. In some embodiments, the extension 14 may measure greater than or equal to 60 inches in total length. In some embodiments, the extension 14 may measure between 40 and 80 inches in total length, inclusive. In some embodiments, extension 14 comprises an adjustable length, wherein extension 14 comprises multiple telescoping sections and/or comprises multiple sections that may be added to, or removed from handle 14 to achieve a desired overall length.

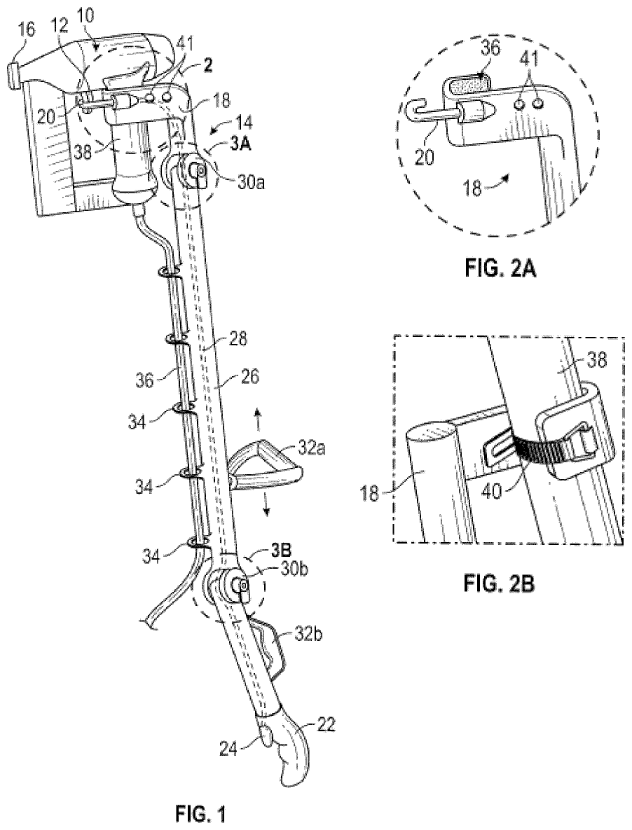

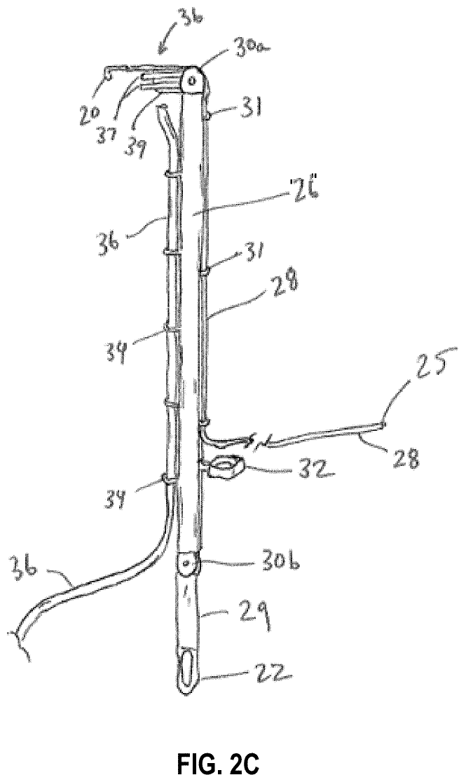

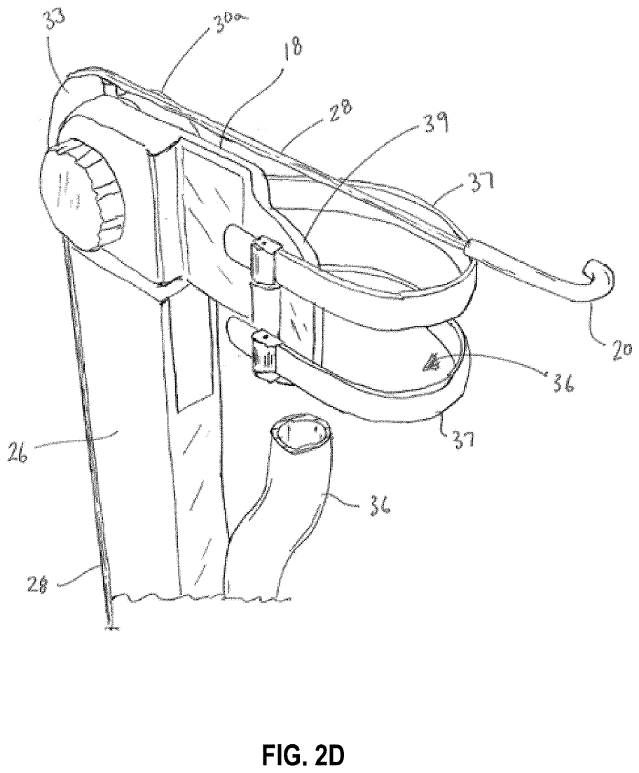

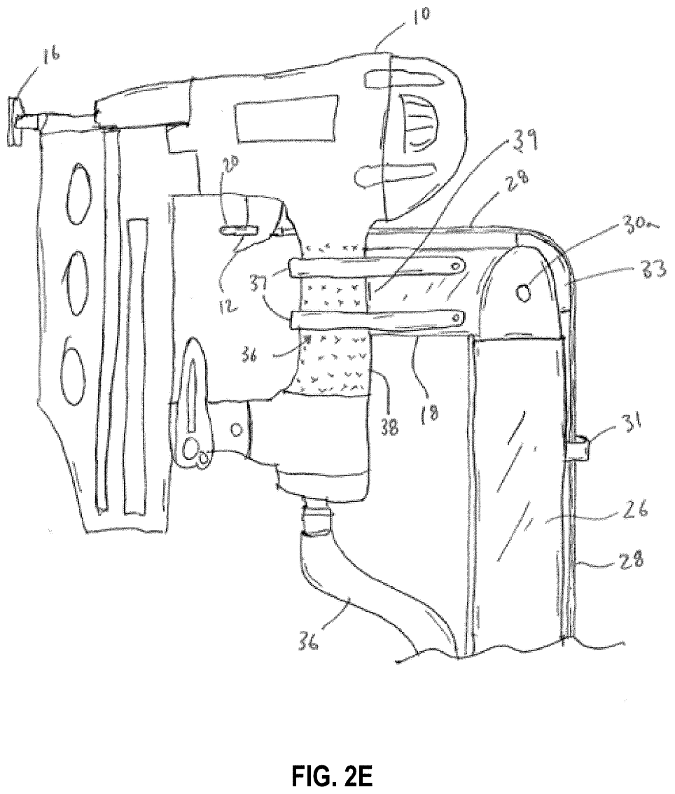

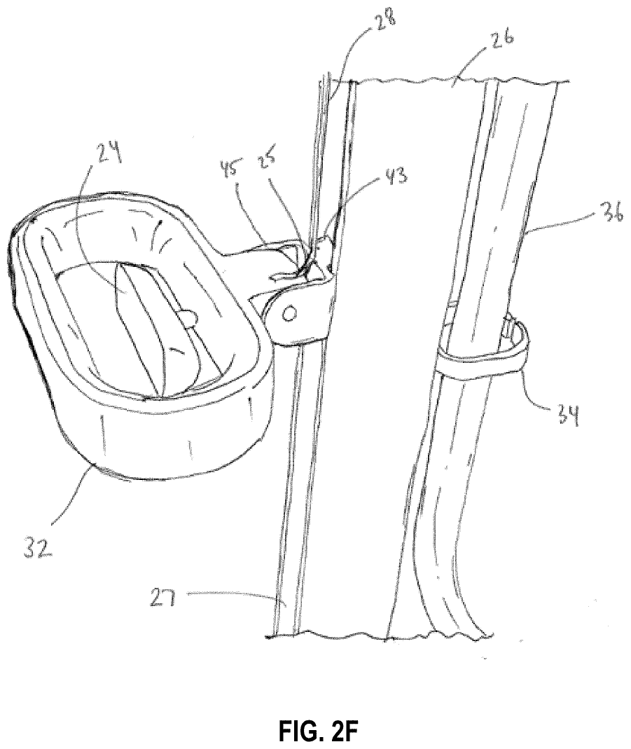

Referring now to FIGS. 2A-2F, in some embodiments, the holder 18 includes an opening 36, which is sized and configured to receive a portion of the nail gun 10. For example, a handle or grip 38 of the nail gun 10 may extend through and be positioned within the opening 36. In some embodiments, opening 36 comprises a U-shaped channel, as shown in FIG. 2A. In some embodiments, opening 36 comprises an enclosed space defined by a plurality of adjustable securing straps 37 and a tool securement platform or interface 39, as shown in FIGS. 2C-2E.

In some embodiments, opening 36 comprises a continuous inner surface. In some embodiments, a contact surface of the opening 36 includes rubber or another suitable material, which may facilitate a secure fit between the nail gun 10 and the holder 18. In some embodiments, opening 36 comprises a non-continuous inner surface.

In some embodiments, opening 36 comprises a U-shaped channel into which grip 38 of nail gun 10 is inserted and secured therein by a securement strap 40 that spans the open end of the channel, as shown in FIG. 2B. In some embodiments, opening 36 comprises a tool securement platform or interface 39 configured to act as a surface against which a portion of the nail gun 10 is biased when secured to extension 14. In some embodiments, an interface 39 is an extension of holder 18 that contacts a grip 38 of nail gun 10. In some embodiments, interface 39 is configured to provide a mounting surface that securely contacts and supports grip 38 when nail gun 10 is placed within opening 36. In some embodiments, grip 38 is biased against and held tightly against an interface 39 of opening 36 when one or more securement straps 37 are tightened, wherein securement straps contact a portion of grip 38 that is opposite the portion of grip 38 in contact with interface 39, as shown in FIG. 2E. In some embodiments, the holder 18 includes a mounting bracket to which the nail gun 10 is secured, such as by one or more fasteners. In some embodiments, the nail gun 10 is mechanically affixed to the holder 18, such as by one or more U-bolts, a bolt-on adapter, a threaded connection, and/or an adhesive, such as an adhesive strip. In some embodiments, a nail gun is provided having one or more features that are compatible for direct attached to at least one of holder 18 and elongated connector 26.

In some embodiments, securement straps 37 and/or 40 are adjustable. In some embodiments, securement straps 37 and/or 40 include an attachment end that is securely coupled to the holder 18, and a free end that is positioned around one or more surfaces or features of nail gun 10. In some embodiments, straps 37 and/or 40 are removable coupled to the holder 18 via a snap, clip, buckle, fastener, bolt, screw, tie, or other suitable mechanism. In some embodiments, the securement strap 40 is elastomeric. In some embodiments, the securement strap 40 includes one or more teeth, which may allow incremental tightening and/or loosening of the securement strap 40 via a releasable ratcheting buckle.

In some embodiments, cable 28 is router over an external surface of extension 14, as shown in FIGS. 2C-2F. In some embodiments, elongated connector 26 comprises a plurality of cable guides 31 positioned along a length thereof of maintained a desired position of cable 28. In some embodiments, extension 14 further comprises one or more articulable cable guides 33 located at one or more pivoting or adjustable elbow joints 30 of the invention, wherein cable guides 33 assist in navigating cable 28 around joints 30 during use. In some embodiments, cable guides 33 are fixedly or rotatably coupled to elongated connector 26 at elbow joint 30a. In some embodiments, cable guides 33 are fixedly or rotatably coupled to holder 18 or a lower extension member 29 at elbow joint 30a or 30b, respectively. In some embodiments, cable guide 33 comprises an independent piece or part that is fixedly or rotatably coupled to extension 14 at an elbow joint 30.

In some embodiments, cable 28 comprises a free end 25 that may be routed to various locations on extension 14 and coupled to one or more handles 22 or 32 at a desired location. In some embodiments, free end 25 of cable 28 is routed to and operably connected to terminal handle 22. In some embodiments, free end 25 of cable 28 is routed to and operably connected to handle 32. In some embodiments, cable 28 comprises two or more cables each having a free end. In some embodiments, cable 28 comprises a single cable having two or more free ends, such as by splicing or otherwise connecting one or more additional free ends to cable 28.

In some embodiments, elongated connector 26 further comprises one or more tracks or channels 27, as shown in FIG. 2F. In some embodiments, various components of the present invention are coupled to one or more surfaces or structures of extension 14 via a channel 27. For example, in some embodiments loops 34 and/or 36 are adjustably coupled to elongated connector 26 via channel 27. In some embodiments, handle 32 is adjustably coupled to elongated connector 26 via channel 27. For example, in some embodiments handle 32 comprises a base 43 that is positioned within channel 27 and configured to secure handle 32 thereto. In some embodiments, handle 32 may be selectively removed from base 43 and replaced with a different handle. In some embodiments, base 43 comprises a receptacle 45 for receiving and securing handle 32. In some embodiments, receptacle 45 enables a hinged connection between handle 32 and base 43. In some embodiments, handle 32 is capable of sliding within channel 27 to be repositioned to a desired location along the length of elongated connector 26. In some embodiments, handle 32 is further capable of pivoting to and maintaining a desired angle. Handle 32 may further comprise a trigger 24 that is operably coupled to free end 25 of cable 28. The same features shown for handle 32 in FIG. 2F may be provided for handle 22 or any other handle of extension 14. In some embodiments, cable 28 is at least partially routed through channel 27. In some embodiments, air hose 36 is at least partially routed through a channel 27.

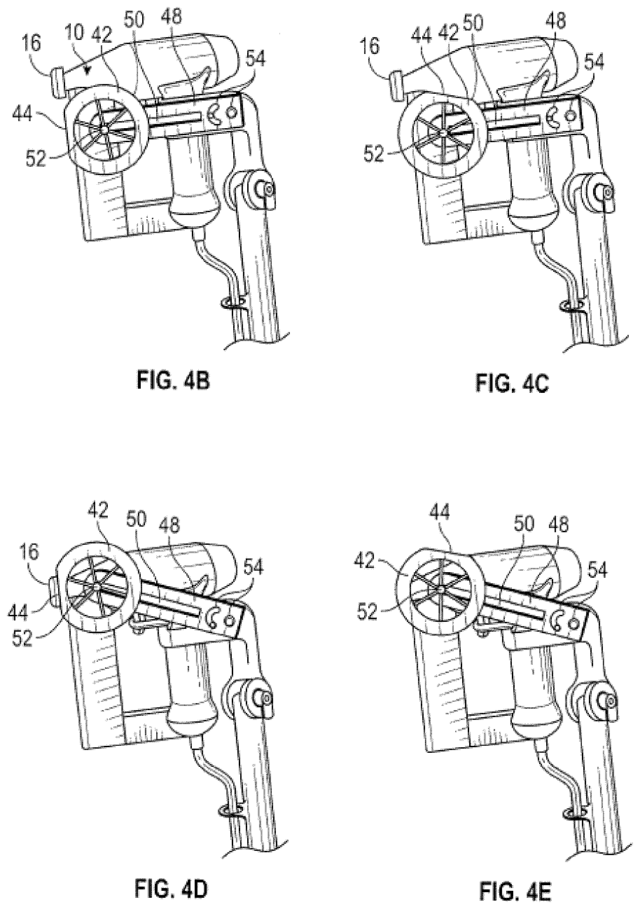

In some embodiments, the extension 14 includes one or more holes 41, which is used to secure a wheel unit 46 (illustrated, for example, in FIGS. 4A-4E) to the extension 14. For example, the holder 18 includes holes 41 and/or holes 41 are proximate or near the holder 18. In some embodiments, holes 41 is sized and configured to receive a screw, rivet, bolt, or other suitable mechanism, as will be discussed later in further detail. In some embodiments, the holder 18 includes two holes 41.

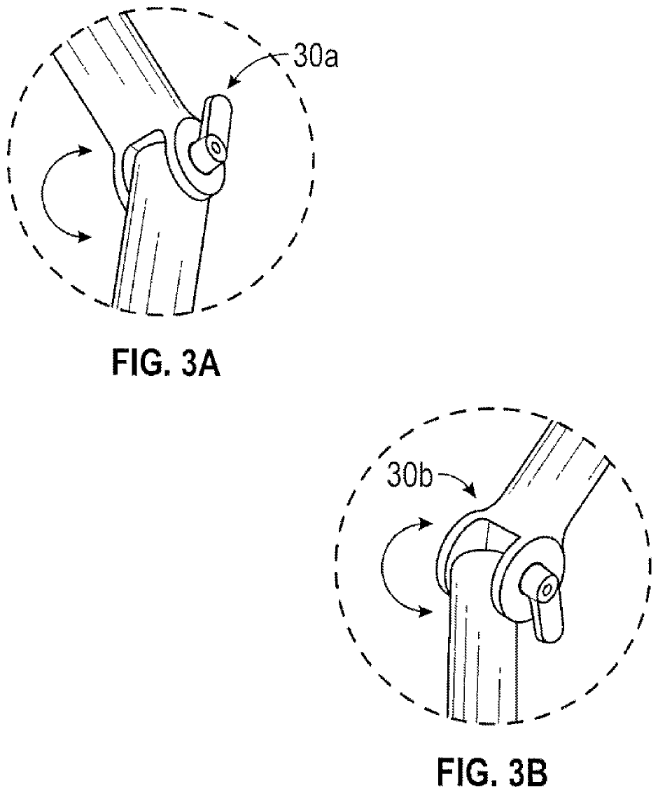

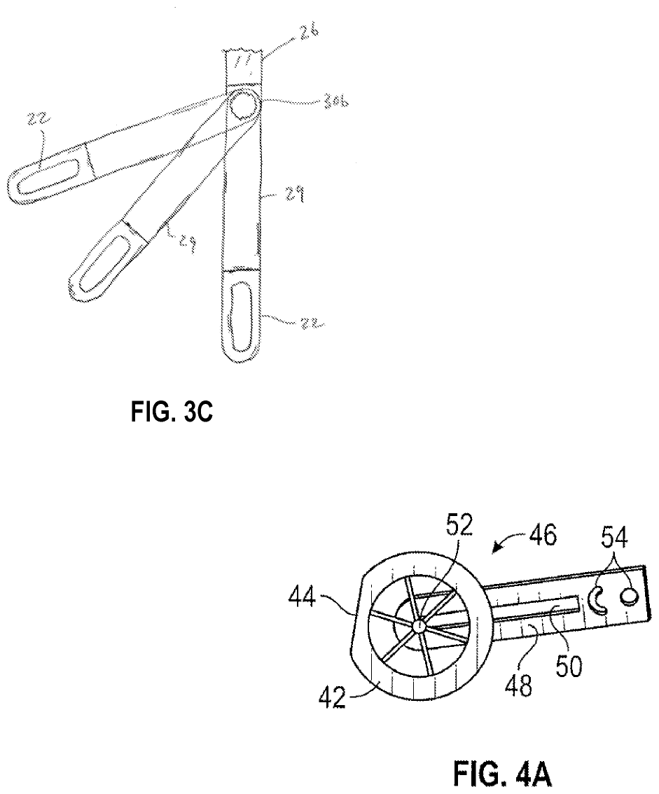

Referring now to FIGS. 3A-3C, in some embodiments, the adjustable elbow joints 30a and 30b are disposed along a length of the elongated connector 26. In some embodiments, the elongated connector 26 includes a first adjustable elbow joint 30a and/or a second adjustable elbow joint 30b, which may separate the elongated connector 26 into an upper portion, a lower portion, and a middle portion. In some embodiments, the adjustable elbow joints 30 is configured to allow the upper portion and the lower portion to pivot independently relative to the middle portion, such that the nail gun 10 secured within the extension 14 can be used at different angles. In some embodiments, an elbow joint 30 is provided between holder 18 and elongated connector 26, as shown in FIGS. 1, 2C-2E and 3A. In some embodiments, an elbow joint 30b is provided between a lower extension member 29 and elongated connector 26, as shown in FIGS. 3B-3C.

In some embodiments, one or more of the adjustable elbow joints 30 is locked in a straight configuration or at an angle according to any mechanism known in the art. For example, in some embodiments the upper portion includes multiple teeth which is moved with respect to multiple corresponding teeth of the middle portion when the first adjustable elbow joint 30a is in an unlocked position. When the first adjustable elbow joint 30a is locked, such as, for example, via tightening of a nut threaded onto a bolt or another suitable mechanism, the teeth and corresponding teeth is locked together, preventing movement at the first adjustable elbow joint 30a. In some embodiments, the second adjustable elbow joint 30b may operate similar to the first adjustable elbow joint 30a.

Referring now to FIGS. 4A-4E, in some embodiments, the extension 14 includes a rotating wheel 42, which is coupled to the extension 14. In some embodiments, the rotating wheel 42 is coupled to the holder 18 of the extension 14 or near or proximate the holder 18. In some embodiments, the rotating wheel 42 includes at least one flat edge 44 disposed along a circumference of the rotating wheel 42. In some embodiments, the rotating wheel 42 is configured to roll along a surface such that the nail gun 10 fires at regular intervals.

In some embodiments, the extension 14 includes the wheel unit 46, which includes the rotating wheel 42 and a support 48 extending between the rotating wheel 42 and a portion of the extension 14, such as, for example, the holder 18. In some embodiments, the support 48 includes a slot 50. In some embodiments, a position of the rotating wheel 42 is adjustable within the slot 50, which may allow use of the extension 14 with nail guns 10 of various shapes and sizes.

In some embodiments, the position of the rotation wheel 42 is adjustable within the slot 50 or along a length of the slot in any number of ways. For example, the position of the rotation wheel 42 is adjustable within the slot 50 or along the length of the slot 50 by means of a bolt 52 aligned with the slot 50. In some embodiments, the rotating wheel 42 and/or the wheel unit 46 is coupled to the upper portion of the elongated connector 26. In some embodiments, the bolt 52 may extend through the slot 50 and a nut on an opposite side of the slot 50 from the rotating wheel 42 is tightened to fix a location of the rotating wheel 42 with respect to the slot 50. It is contemplated there are numerous ways to secure the rotating wheel 42 within the slot 50.

In some embodiments, the support 50 includes one or more corresponding holes 54 configured to correspond to or align with the holes 41. In some embodiments, at least one of the holes 41 is non-circular. For example, at least one of the holes 41 is oblong or arc-shaped. Additionally or alternatively, at least one corresponding hole 54 of the support 50 is non-circular. For example, at least one of the corresponding holes 54 is oblong or arc-shaped, as illustrated, for example in FIG. 4A.

In some embodiments, an oblong or arc-shaped hole 41 and/or an oblong or arc-shaped corresponding hole 54 may allow an angle of the rotating wheel 42 with respect to the extension 14 to be adjusted. In some embodiments, the holes 41 and corresponding holes 54 is configured to receive a screw, rivet, bolt, or other suitable mechanism for adjustably securing the rotating wheel 42 to the holder 18 or another portion of the extension 14 in a fixed manner. In some embodiments, a nut threaded to the screw is tightened to lock the wheel unit 46 in position. In some embodiments, a particular corresponding hole 54 disposed forward or towards the safety tip 16 of the nail gun 10 with respect to another particular corresponding hole 54 is non-circular and the other particular corresponding hole 54 is circular.

In some embodiments, the extension 14 may not include the rotating wheel 42 and/or the wheel unit 46. In some embodiments, the rotating wheel 42 is removably coupled to the holder or another portion of the extension 14. For example, one or more screws, rivets, or bolts securing the support 48 to the extension 14 is removed. As another example, the rotating wheel 42 and/or the wheel unit 46 is unsnapped from the extension 14.

As mentioned, in some embodiments, an angle of the rotating wheel 42 with respect to the extension 14 is adjustable. As illustrated in FIGS. 4D-4E, in some embodiments, an angle of the rotating wheel 42 is adjusted such that an outer circumference of the rotating wheel 42 is aligned with the safety tip 16 of the nail gun 10, which may allow the rotating wheel 42 to be rolled along a surface, with firing of the nail gun 10 occurring at regular intervals.

In some embodiments, the wheel unit 46 and the extension 14 may allow the user to operate the nail gun 10 to fire nails in a smooth, continuous motion and/or evenly spaced apart. In some embodiments, the rotating wheel 42 includes one or more flat edges 44 disposed along the circumference of the rotating wheel 42, which may produce an uneven rolling pattern of the rotating wheel 42. In some embodiments, the intervals between the regular edges and flat edges 44 on the rotating wheel 42 cause the nail gun 10 to move up and down, or towards and away from the nailing surface, as the user rolls the rotating wheel 42 and nail gun 10 across the nailing surface, such as a floor or wall, for example. In some embodiments, if the user sets a rounded or non-flattened outer edge or surface of the rotating wheel 42 flush with, in alignment with the safety tip 16, the rotating wheel 42 distances the safety tip 16 from the nailing surface, thereby preventing the safety tip 16 from being compressed against the nailing surface and firing the nail gun 10. In some embodiments, as the rotating wheel 42 and nail gun 10 are rolled across the nailing surface, alternating surface elevations or heights along the outer circumference or edge of rotating wheel 42 changes the distance between the nailing surface and safety tip 16, thereby actuating or depressing safety tip 16 each time a flat edge 44 contacts the nailing surface, which in turn readies nail gun 10 to fire a nail. In some embodiments, trigger 12 is continuously actuated by the user, whereby nail gun 10 automatically fires each time flat edge 44 contacts the nailing surface as rotating wheel 42 is rolled along the nailing surface.

In some embodiments, the flat edges 44 is evenly spaced along the circumference of the rotating wheel 42, which results in firing of nails at a desired interval. In some embodiments, a desired interval is a constant interval. In some embodiments, the flat edges 44 may allow a spacing between the nails to be regular and exact, such as every 3, 4, 6, 8, or 12 inches. In some embodiments, by replacing or interchanging a particular rotating wheel 42 with another rotating wheel 42 having a different number of flat edges 44, a different length of flat edges 44, a different outer circumference, or an oblong outer circumference shape, the user may alter the spacing between the nails.

In some embodiments, a rotating wheel of the present invention comprises a plurality of adjustable outer, circumferential, or perimeter edges that may be individually adjusted to provide one or more round surfaces or edge settings. In some embodiments, a rotating wheel is provided comprising a centrally-located dial that may be turned or otherwise actuated by a user to select between one or more edge settings. In some embodiments, a rotating wheel comprises a plurality of discs each having at least one rounded edge surface, wherein the discs are stacked or sandwiched together within the rotating wheel such that at least one round edge surface of one disc is out of phase with at least one round edge of another disc of the rotating wheel. In some embodiments, each disc comprises a hole through which a keyed shaft of a dial is inserted, wherein the keyed shaft contacts and moves at least one of the discs relative to one or more of the remaining disc, wherein the keyed shaft moves the disc to a position whereby a round surface of the disc is positioned at the outer circumference of the rotating wheel. In some embodiments, the dial of the rotating wheel comprises a plurality of positions to which it may be rotated and/or set to provide a desired number of round surfaces on the perimeter or circumferential edge of the rotating wheel. In some instances, a keyed shaft of the dial simultaneously contacts and moves two or more disc to provide three or less round surfaces, wherein the remaining surfaces of the perimeter or circumferential edge of rotating wheel are flat.

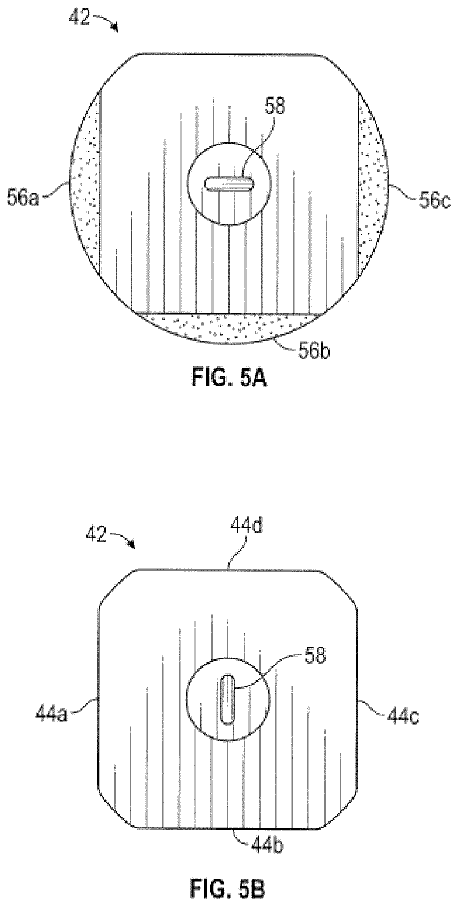

Referring now to FIGS. 5A-5B, a representative embodiment of a rotating wheel 42 is shown. In some embodiments, the rotating wheel 42 includes one or more adjustable edges 56, which may each be movable between a retracted and an extended position. In some embodiments, in response to a particular adjustable edge 56 being disposed in the retracted position, a particular flat edge 44 of the rotating wheel 42 is exposed. In some embodiments, the rotating wheel 52 includes a knob 58, which is rotated to move one or more of the adjustable edges 56 to the retracted position. In some embodiments, the knob 58 is rotated to move one or more of the adjustable edges 56 to the extended position. In some embodiments, the knob 58 is rotated a first amount in a first direction to move a particular adjustable edge 56 to the extended configuration, and a second amount in the first direction to move a particular adjustable edge 56 to the extended configuration. In some embodiments, the knob 58 is rotated in a second direction opposite to the first direction to move a particular adjustable edge 56 to the retracted position.

FIG. 5A illustrates three adjustable edges 56a, 56b, and 56c in the extended position, according to some embodiments. FIG. 5B illustrates the three adjustable edges 56a, 56b, and 56c in the retracted position such that the corresponding flat edges 44a, 44b, and 44c are exposed. In some embodiments, the adjustable edges 56 may allow the user to change a spacing between the nails fired into the surface without replacing the rotating wheel 42. In some embodiments, the rotating wheel 42 includes a tire, and one or more portions of the tire are removed to create the flat edges 44.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

1. An extension for a nail gun, comprising:
a holder sized and configured to receive the nail gun;
an actuator;
a handle having a trigger, wherein the trigger of the handle is operably coupled to the actuator such that in response to actuation of the trigger of the handle, the actuator is configured to actuate a trigger of the nail gun; and
an elongated connector disposed between the holder and the handle.

2. The extension of claim 1, wherein the trigger of the handle is operably coupled to the actuator via a cable routed across the elongated connector.

3. The extension of claim 1, wherein the trigger of the handle is operably coupled to the actuator via a wireless connection.

4. The extension of claim 1, wherein the elongated connector comprises an adjustable elbow joint.

5. The extension of any of claim 1, wherein the holder comprises an opening through which the nail gun is configured to extend.

6. The extension of claim 1, wherein the holder comprises a securement strap.

7. The extension of claim 1, wherein the actuator comprises a hook.

8. The extension of claim 1, further comprising a rotating wheel coupled to the extension, wherein the rotating wheel comprises a flat edge disposed along a circumference of the rotating wheel, wherein the rotating wheel is configured to roll along a surface such that the nail gun fires at regular intervals.

9. The extension of any of claims 1 to 7, wherein the rotating wheel is removably coupled to the extension.

10. The extension of claim 8, wherein an angle of the rotating wheel with respect to the extension is adjustable.

11. The extension of claim 8, further comprising a support extending between the rotating wheel and the holder, wherein the support includes a slot, wherein a position of the rotating wheel is adjustable within the slot

12. The extension of claim 1, wherein the elongated connector comprises a first adjustable elbow joint disposed towards the holder and a second adjustable elbow joint disposed towards the handle.

13. The extension of claim 12, wherein the handle is a first handle, further comprising a second handle disposed between the second adjustable elbow joint and the first handle.

14. The extension of claim 12, wherein the handle is a first handle, further comprising a second handle disposed between the first and second adjustable elbow joints.

15. The extension of claim 1, wherein the elongated connector comprises a plurality of loops configured to hold at least one of an air hose of the nail gun and a portion of the actuator.

16. The extension of claim 1, further comprising a rotating wheel coupled to the holder, wherein the rotating wheel comprises a plurality of adjustable edges each movable between an extended and a retracted position, wherein the rotating wheel is configured to roll along a surface such that the nail gun fires at regular intervals.

17. An extension for a nail gun, comprising:
an elongated connector having a first end and a second end;
a holder disposed at the first end of the connector, wherein the holder is sized and configured to receive the nail gun;
an actuator;
a handle disposed at the second end of the connector, the handle having a trigger, wherein the trigger of the handle is operably coupled to the actuator such that in response to actuation of the trigger of the handle, the actuator is configured to actuate a trigger of the nail gun.

18. The extension of claim 17, wherein the elongated connector comprises a rod.

19. The extension of claim 17, wherein the elongated connector comprises a plurality of adjustable elbow joints.

20. The extension of claim 17, wherein the elongated connector comprises a plurality of additional handles.
